(19) United States
(12) Patent Application Publication
(10) Pub. No.: US 2004/0244283 A1
(43) Pub. Date: Dec. 9, 2004

(54) Revolutionary non-polluting, air-tight, temperature regulated, cultivation system

(76) Inventor: Shu-Chin Chen, Pingjhen City (TW)

Correspondence Address: RABIN & BERDO, P.C., Suite 500, 1101 14th Street, N.W., Washington, DC, 20005, US

(21) Appl. No.: 10/775,073

(22) Filed: Feb. 11, 2004

(30) Foreign Application Priority Data
Apr. 22, 2003 (TW) 92109429

(51) Int. Cl. A01G 9/00

(52) U.S. Cl. 47/17

(57) ABSTRACT

This invention is aimed at reducing the use of water, eliminating the use of pesticides, reducing the nitrate content of vegetables at harvest time, reducing the seasonal effects on farming thus allowing year round agriculture (change), also reducing the influence on the cultivation behaviors, and allowing seeding and harvest everyday.

### BACKGROUND OF THE INVENTION

1. Field of the Invention

This invention relates to 1. a sowing mechanism that requires no soil and eliminates contamination and uses a fraction of water as compared to conventional farming, 2. creating a clean environment free of contamination 3. a mechanism to regulate the indoor temperature efficiently using the endothermic and exothermic properties of water, and solar radiation, 4. an innovative planting and harvesting mechanism that makes maximum use of space, 5. a method to precisely control the amount of nutrients given to the vegetation, 6. a mechanism to maximize the growth of vegetation by controlling the environmental factors such as light, nutrient and temperature.

2. Description of the Prior Art

The evolutional process of human society is by turns of fishing, hunting, animal husbandry, and then agriculture etc. In the last 200 years, agricultural revolution (green revolution) improved the efficiency of farming and now most of the developed world is free of starvation. However, with agricultural revolution comes soil overuse so farmers have taken various steps to fertilize the land using chemicals to achieve maximum land use. But the activity of sowings under such a vicious circle caused soil to become severely acidic. As a result more farmers began to pay attention the land preservation and reverted to the traditional cultivation of farming without pesticides and chemical fertilizers. Nevertheless, the ecosystem has been severely damaged from years of aggressive and destructive practices that the land is unable to recover on its own and this forces even more aggressive fertilization and the use of pesticides by farmers to compensate for the ineffectiveness of the land. In the end, pesticides are accumulated in the soil and its residues find their way into the food chain, and this causes the extinction of species and well as posing a health risk for the consumer. One of the main goals of this invention is to eliminate the use of pesticides, prevent additional contamination to our Earth, cut off infection path of parasite and at the same time producing pristine crops that are beneficial to our health.

### SUMMARY OF THE INVENTION

The first preferred embodiment of the invention is to improve the process of traditional agriculture by saving large amount of irrigation water. In traditional farming, most of the irrigation water is not absorbed by the plant or vegetable but instead they are lost through the ground, run offs, or evaporation. By sowing in the innovative cultivation system we maximize the use of water. This is also different from traditional hydroponics, which immerses the roots of plant in water thus needs a large amount of water and risks contaminating the environment.

Another preferred embodiment of the invention relates to a mode of planting vegetation without the use of pesticides. Controlling pests has become increasingly important due to the destruction of the ecosystem, which in the past was able to balance the growth of one species with another. The pesticides tilt the balance and the more resistant species thrived at the expense of less resistant species. As the pests became more resistant to the pesticides more quantity of it has to be used. And this vicious cycle continues endlessly. By growing vegetation in the present airtight contaminant-free system, the pests are eliminated and therefore no pesticides are necessary.

The third preferred embodiment of the invention relates to preventing parasitic eggs from polluting vegetation. Eating raw vegetable is a healthy way to receive unspoiled nutrient yet to do so there's a risk of ingesting parasites eggs such as ascarid, hookworm, threadworm or liver fluke just to name a few. Indeed even cooking can't completely eliminate these eggs as some of them are resistant to high temperature. A method of cultivation, hydroponics, was developed to combat parasitic eggs contamination but this method has major drawbacks. That is nitrite poisoning in the vegetation. The roots of plants immersed in nitrite rich nutrient water cannot receive enough oxygen for proper metabolism and therefore at harvest time often still contain levels of nitrite higher than acceptable for consumption. The leaves also may contain higher than safe levels of nitrite due to the stifled metabolism. Again, by growing vegetation in the present airtight contaminant-free system, parasitic eggs are eliminated without hydroponics.

The fourth preferred embodiment of the invention relates to improve the situation of nitrate accumulation. The present invention can reduce nitrate accumulation of vegetable that impacts human heath. The roots of vegetable in the soil can breathe oxygen freely due to the small gaps between each soil particle and sand. When roots of vegetable breathe oxygen into vegetable that let nitrate be oxidated quickly. As long as the sunlight is ample, the accumulation of nitrate can be eliminated. However, if there is insufficient photosynthesis during harvest time, it is possible to have excess of nitrate accumulation in the leaves and stems of vegetable even when planting vegetable in the soil. As for the hydroponics vegetable, the roots always immerse in the nutrient solution for long period of time and cannot breath oxygen directly. In addition, there is still high concentration of nitrate in the nutrient solution even during harvest time. It is different from sowing vegetable in the soil that farmers will generally stop applying fertilizers before harvest. This is main reason hydroponics vegetable usually stores too much nitrate contents. The minimum contents of nitrate for a healthy definition are the concentration of nitrate in the vegetable is 2000 ppm.

The main source of nitrogenous fertilizers for sowing plant in the soil is urea [CO(NH₂)₂]. Nevertheless, urea cannot be absorbed directly by the roots of plants (root nodule exception). The nitrogen element of urea must be converted to ammonia (NH₃) or nitrate through bacteria or fungus in the soil. Then ammonia is converted to nitrite ion (NO₂−) by nitrification bacteria. Yet again nitrite ion will be converted to nitrate ion by nitrification bacteria. After a process of conversion, the nitrate ion can start to be absorbed by the roots of plants. Then nitrate ion can be amino acids through photosynthesis reaction and will finally become protein of vegetable. For the entire mechanism of conversion, it starts with urea firstly converted to ammonia by bacteria or fungus and then converted to nitrate, then absorbed by vegetable to be amino acids through photosynthesis, and finally be protein to make vegetable grow. In the nature there is only root nodule with a special bacteria that can absorb ammonia or nitrogen element. The chemical reaction of converting ammonia to the components that plants can absorb directly is called a nitrification reaction and defined by equation (1).

[(NH₄+)→(nitrification bacteria)→(NO₂−)→(nitrification bacteria)→(NO₃−)] (1)

The nutrient solution (fertilizers) that conventional hydroponics usually uses includes nitrogen, phosphor, potassium, calcium, magnesium, sulfur etc. The main source of nitrogenous fertilizers of nutrient is nitrate instead of urea such as calcium nitrate, and potassium nitrate etc., because of no the same bacteria as soil for the hydroponics system. However, the long immersing time of the roots of hydroponics vegetable in the nutrient solution keeps nitrate being absorbed and cannot finally have an effective metabolism prior to harvest. Hence the contents of nitrate in the leaves and stems of hydroponics vegetable must be much higher than the normal limitation. The solutions are to control the concentration of nitrate in the nutrition liquid and throttle the supply of the nutrition for each step of the vegetation growth based on the environment. By controlling the supply of the nutrient solution, according to the amount of light exposure, the temperature of the environment, the maximum growth is achieved and the nitrite concentration in vegetation is minimized. For example, the present invention provides a higher concentration of the nutrient to promote the growth of vegetable on sunny days and less concentration on days that are overcast. Since the photosynthesis can speed the conversion of the absorbed nitrate into amino acids then ultimately to protein in the growing process of vegetable. On the contrast, it needs to lower the concentration of nitrate in the nutrient solution during overcast or a rainy day, in case the insufficient photosynthesis causes accumulation of nitrate in the leaves and stems of hydroponics vegetable. The large amount of nitrate will be converted to ammonium nitrite that has adverse effects on human's health through the digestive system. The present invention is also to improve above drawbacks of hydroponics by way of stopping the supply of nutrient (nitrate) before the harvest time and substitute it with water. This provides fuel for the basic metabolism of vegetable and enables the residuary nitrate inside vegetable to convert to amino acids completely thus reducing nitrite concentration in vegetable to safe levels at harvest time.

The fifth preferred embodiment of the invention relates to cultivation without polluting the soil with fertilizers. This prevents the soil of farmland from deteriorating and becoming acidic. Also since the environment isn't affected by each cycle of farming the same area can be sown immediately after harvest, thus maximizing the land usage. This method also can precisely control the amount of fertilizers given to the plant by the present airtight contaminant-free system. Together with a predetermined fertilization schedule, different doses of nutrients can be administered at each stage of development thus making effective use of nutrients. This invention spares the soil from fertilizer pollution and makes effective use of fertilizers.

The sixth preferred embodiment of the invention relates to improving many drawbacks of traditional hydroponics. There are two major problems in hydroponics both of which are addressed by the invention. Firstly, the liquid nutrient can either run-off or discharge into rivers and damaging the environment. Secondly, immersing the root in nutrient solution promotes growth of bacteria and algae and can cause it to decay faster than otherwise. In this invention, the root is suspended in the air, not immersed in solution. Nutrients are given at precise intervals in accordance with the amount of light available which will lessen the chance of the root decaying and provide better growing environment for vegetations.

The seventh preferred embodiment of the invention relates to reducing the effects of seasonal change on farming. In the past, farmers decide what to plant based on the season because vegetation requires a certain climate to flourish. And since there's only a window of opportunity to seed in order to harvest at the right time all seeding must be done at the same time. This is labor intensive and to harvest all vegetation at the optimal time is a difficult task. And also it will cause the sale price drop when produce a great deal of vegetation at the same period of time. By taking complete control of the environment by regulating the temperature, light exposure, and nutrient input, vegetation can now be grown and harvested everyday throughout the year, freeing the farmer from seasonal constraints and manpower restriction. In the present invention the most appropriate range of temperature for a variety of vegetable is defined as between 22° C. and 30° C. during summertime and between 12° C. and 30° C. during wintertime. Then it is to choose the optimal temperature range for the necessity of each kind of vegetation. In the subtropical zone the relative humidity ranges from 50% to 90%. It is not suitable to grow vegetables at a temperature above 35° C. and below 5° C.

The eighth preferred embodiment of the invention relates to making seeding and harvesting process into mass production level. In this process, like that of a modern factory, the product is at various phases of production and in the same way the vegetation is at various stages of maturity. Everyday, once the first group matures, harvesting is done and seeding is also done to take place of the more mature siblings. If period of 35 days is chosen for the particular vegetation growth it will take 35 days to populate the production line and on the 36^{th} day harvest begins. But instead of harvesting every plant only 1/35 of the plant is mature and can be harvested. An ingenious system is set up to move the cultivating trays from beginning to end. The trays vary in size with the ones nearer the beginning of the production smaller and then becoming larger as it moves towards the end. This is done to maximize space use since the vegetation increases in size as it matures and therefore requires more room. This invention reduces the amount of labor needed for seeding and harvesting and also reduces the amount of space needed to plant vegetations.

### BRIEF INTRODUCTION TO THE DRAWINGS

(I) Drawings

FIG. 1 is a top view showing one example of the greenhouse with clean and airtight cultivation system according to the present invention.

FIG. 2 is a graph showing the system of temperature regulation and dust filtration.

FIG. 3 is showing one example of the greenhouse with a cultivating area, a seedling nursery area, a harvest area, cultivating ditches and a nutrient solution preparation system according to the present invention.

FIG. 4 is a cross sectional view showing the cultivating ditches, the cultivating trays and the way to supply nutrient solution.

FIG. 5 is a graph showing the nutrient solution preparation system.

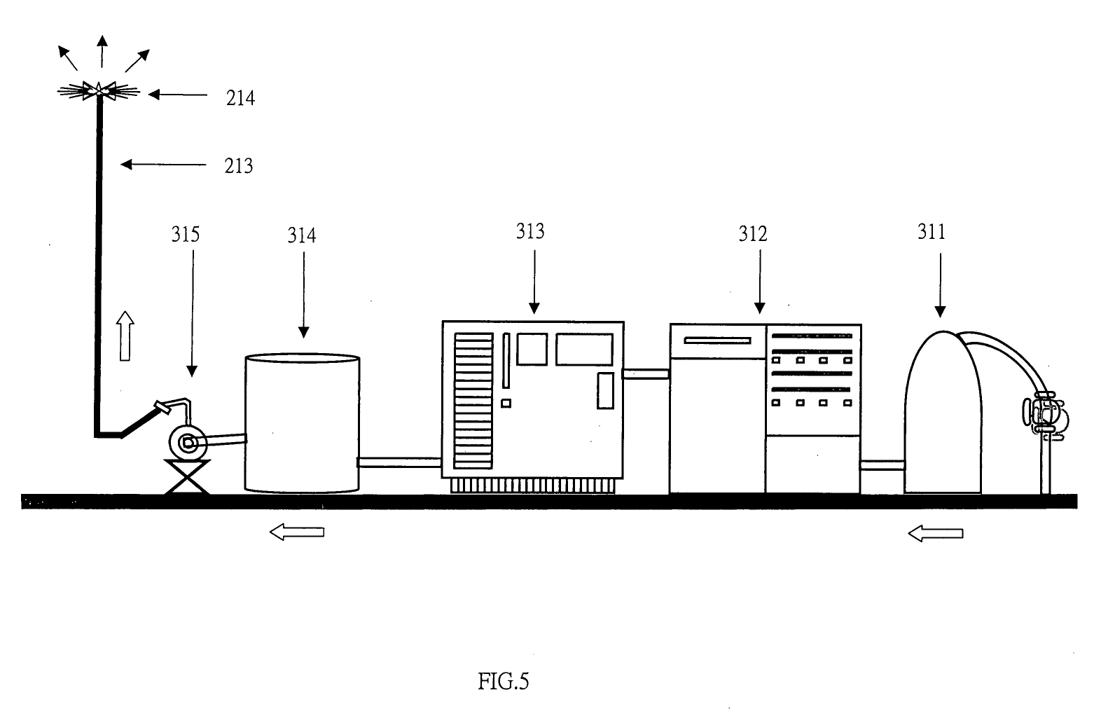

### (II)Code numbers

(1) heat exchange system

(11) incoming water filtering pool

(12) incoming water pump

(13) incoming water hose

(14) air washing machine

(141) nozzles

(142) plate type heat exchange device

(15) drain

(16) blower

(17) high-pressure blowing hose

(18) incoming air filtration device

(19) outgoing air filtration device

(2) cultivating area of clean and airtight greenhouse

(21) cultivating area

(211) cultivating ditches

(212) cultivating trays

(213) nutrient delivery pipe

(214) nutrient spray nozzle

(215) slippery rails

(22) seedling nursery area

(223) seedling nursery trays

(224) vibrating and line-arranging machine

(225) ultraviolet lamp

(226) isolating door

(227) isolating door

(228) airtight entrance gate

(23) harvest area

(231) gas chromatography device

(31) nutrient solution preparation system

(311) filter

(312) heater

(313) cooler

(314) nutrient solution preparation tank

(315) nutrient solution pump

### DETAILED DESCRIPTION OF THE INVENTION

The applicant of this environmental protection greenhouse with clean and airtight cultivation system is an expert who has run agricultures for some time and has seen the difficulties of growing fresh vegetables using traditional methods. The applicant focuses on improving the shortcomings of the traditional agriculture by applying methods learned from advanced modern production methods widely used in pharmaceutical production. In addition, the applicant applies the Laws of Thermodynamics to regulate the green house temperature efficiently using minimal amount of energy. During the summer the present inventive method uses the endothermic capability of water to lower the temperature of hot air, using a heat exchange system. In this system, external hot air is blown into the air cleaning machines with heat exchange plates inside. After the temperature of hot air is reduced through the heat exchange mechanism, the air is blown into the greenhouse to lower the internal air temperature. The innovation creates a suitable temperature condition for vegetable growth and applies the Second Law of Thermodynamics i.e. ΔS>ΔQ/T (an irreversible reaction), ΔS is “entropy change”, ΔQ is “transfer of energy” and T is the temperature of the system. In addition, the present inventive method applies the First Law of Thermodynamics i.e. the total energy of the system plus the surroundings is constant and also energy is conserved. By assuming no additional energy loss, it can be defined that the air washing machine is an isolated system and the endothermic energy of water is equal to the exothermic energy of hot air after going through heat exchange mechanism. Through the heat exchange, the heat in the hot air is transferred to water and the resulting cool air is used to lower the temperature of the airtight greenhouse.

The present invention assumes the area of the clean and airtight greenhouse to be 1400 square meters and the height to be 2 meters, then the volume is 2800 cubic meters. In order to control the temperature of the clean and airtight greenhouse, enough heat exchange capabilities must be provided to counter act the heats of summer and coolness of winter. The following provides a detailed calculation of the amount of heat that must be dissipated in the summer and added in the winter. It then proposes a system, the invention, to accomplish this in an efficient manner. In addition, detailed drawings of the growth system are provided with descriptions of the production process.

When the solar radiation reaches the atmospheric layer, around 34% of radiation will be reflected back to space by the atmospheric molecules and clouds. In addition, 19% of radiation will be absorbed by the atmospheric layer, hence around 47% of radiation can reach the surface of the earth. The total energy of solar radiation brings the heat to the clean and airtight greenhouse is about 430.2 Kcal/hr per square meter (0.13 RT, refrigeration ton). When the leaves of vegetable goes through photosynthesis, it use the energy of solar radiation and combine carbon dioxide with water absorbed from roots to synthesize carbohydrates and release oxygen. The maximum energy of solar radiation in the summer is 1000 W/m². The photosynthesis of vegetable can absorb about 1˜2% of energy and the tempered glass of greenhouse can consume about 3˜5% of energy and including the 500 CCM of air exchange of the airtight greenhouse that subtracts about 43˜46% of solar radiation. Hence it consumes total around 50% of solar radiation, and around 50% of residuary solar radiation will be changed to heat in the airtight greenhouse that is an essential part and needs to be solved in the present invention. The conversion formula is 1 W=1 J/m²/sec and 1 J/m²/sec=60 J/m²/min. Therefore, the heat from the solar radiation in the present production example is 30 KJ/m²/min (from the equation Q=1000 W/m²×50%=500 W/m²; 500 W/m²=500 J/m²/sec; 500 J/m²/sec×60 sec=30,000 J/m²/min=30 KJ/m²/min) and 1 J=0.000239 Kcal, so the heat energy per meter per minute is 7.17 Kcal/m²/min (from the equation 30,000 J/m²/min×0.000239 Kcal=7.17 Kcal/m²/min), so that the heat energy per meter per hour is 430.2 Kcal/m²/hr. The area of the greenhouse is 1400 m² and the heat from the solar radiation is 602,280 Kcal/hr.

From above equations, the heat from solar radiation into the clean and airtight greenhouse in the present production example is 602,280 Kcal/hr. In order to lower the temperature raised by 602,280 Kcal/hr, the present production example needs to remove over 602,280 Kcal per hour from the clean and airtight greenhouse through heat exchange mechanism. To increase the success rate, twice the requires amount will be provided by the system. (2×602,280 Kcal/hr=1,204,560 Kcal per hour)

The present heat exchange system is the application of the formula (ΔQ>ΔS×T). In the summer the water provides endothermic function for the clean and airtight greenhouse. In the winter, especially at night, the role is reversed when the water temperature is higher than that of the ambient temperature. The water now provides exothermic function for the greenhouse. During the winter daytime, using the solar radiation directly can increase the clean and airtight greenhouse's temperature.

The refrigeration ton unit (RT) of air conditioners is defined as the heat absorbed by one ton of 0° C. water causing it to become 0° C. ice completely by the end of one day (24 hours), and 1 RT=3,320 Kcal/hr. The present production example converts the heat energy to refrigeration ton and the calculation is as follows.

The heat should be moved from the clean and airtight greenhouse is 1,204,560 Kcal per hour that is 363 RT. By providing a cooling system that is twice the required theoretical amount, this will take into account for the fact that this is not an ideal isolated system and mechanical friction can reduce the ability to heat exchange. Moreover, in some specific weather conditions the temperature difference between water and the hot air might be narrowed thus lowering the overall capability to exchange heat. The designed system takes into account for these imperfections in the system by providing ample margin for error.

The maximum amount heat of the present production example that has to be removed from the clean and airtight greenhouse is 1,204,560 Kcal per hour or 363RT. According to the theory of thermodynamics, the present production example should transfer the affected heat of the clean and airtight greenhouse to water by the heat exchange mechanism of the air washing machine. It is to use the heat exchange capability of water through endothermic and exothermic reactions and to reduce or raise the air temperature of the clean and airtight greenhouse. The calculation for the necessary amount of water needed to achieve this is as follows:

The specific heat value of water is 1 cal/g° C. and the volume of 1 ton of pure water is 1 m³. It is known that amount of heat needed to be removed from the greenhouse is 363 RT. Hence it needs over 363 ton of cycling water per hour to transfer the heat of hot air to water through the heat exchange mechanism. This breaks down to 6.05 ton of cycling water per minute.

Again, in our present production example, the maximum amount of heat that the system needs to remove is 1,204,560 Kcal per hour. The present production example defines the area of the greenhouse to be 1,400 m² and the height to be 2 m, so the volume of the greenhouse is 2800 cube meter. The air volume unit is CMM (cube meter per minute). To achieve suitable ventilation the system will completely recycle the air 10 times an hour or once every 6 minutes. 2800 cm/6 m=466.6 m³. And a blower with a rating of 500 CMM is chosen for this purpose.

The present production example also chooses an air washing machine with 400 ton/hr heat exchange capability (>363 ton/hr) and a pump suitable for 6.05 ton/min of cycling water. The air washing machine is a still apparatus that consumes no power. The power consumption of the water pump is 25 Kw/hr with 6.05 ton/min of cycle water and 5 meters of lift. When the outside temperature of the greenhouse is lower than 20° C., it needs not turn on the water pump but simply blow air into the greenhouse to lower the temperature. When the inside temperature of the greenhouse is lower than 28° C., it needs not turn on the air blower. Hence the total power consumption is merely 50 Kw/hr, when both air blower and water pump are both working. From the above description the present production example has low power consumption and has the additional benefit of saving irritation water, free of pesticides, no leaking of nutrient solution into the environment, avoiding the pollution of parasite, no negative impact on the environment, lowering the nitrate content in vegetables. When vegetable undergoes photosynthesis in intense light, it increases the consumption of carbon dioxide. The present production example provides a 500 CMM blower to replenish the carbon dioxide that the vegetable needs in photosynthesis, thus providing a suitable environment for the growth of vegetable.

During the daytime of winter in the present production example, it is to receive solar radiation and accumulate heat in the greenhouse. The solar radiation increases the temperature of cool air inside the greenhouse and makes the temperature range of vegetable growth environment be between 12° C. and 30° C. The greenhouse is isolated by the glass structure, and is difficult to have convection and conduction of air between inside and outside the greenhouse. It causes “greenhouse effect” and this provides a suitable temperature range for vegetable growth during winter. The present invention applies the Law of Thermodynamics to improve the drawbacks of traditional cultivation technology and provides an economical and environmentally friendly cultivation method for farmers of the future.

In traditional farming, whether it be planting in the soil or hydroponics, it's not possible to isolate the plants from its environment which deals it with harsh elements such as parasites and extreme temperature changes. The conventional method for defending the parasitic eggs has the drawbacks of polluting both the plant and the environment. Hydroponics has drawbacks of leaving high levels of nitrate in the plants and thus posing health risks for the consumer. The present airtight and clean greenhouse system applied concepts of Laws of Thermodynamics to regulate the environmental temperature for most suitable vegetable growth and isolates vegetable cultivation from the outside environment. This is superior to the traditional ventilation net construction, which cannot protect the plant from harsh environments. The production and marketing process of vegetable in the present invention models after modern industrial process in the food industry from seeding, germinating, growing, harvesting, quality control, packaging and delivery. All the processes are under a standard quality control procedures enabling investigating, recording, adjusting, tracing and destroying of the product. This makes the “manufacturing” of vegetables conform to a safe and sanitary standard of food production process known as GMP.

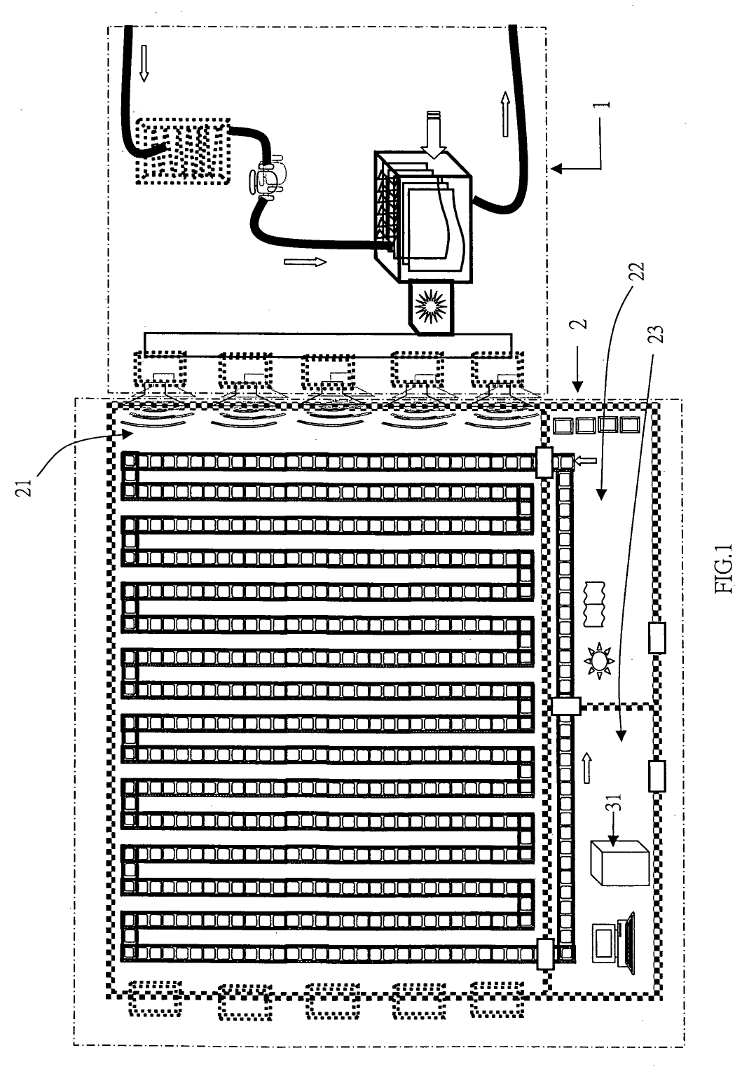

As seen in FIG. 1, the environmental protection greenhouse with clean and airtight cultivation system includes a heat exchange system (1) of temperature adjustment, a cultivating area (2) of the clean and airtight greenhouse.

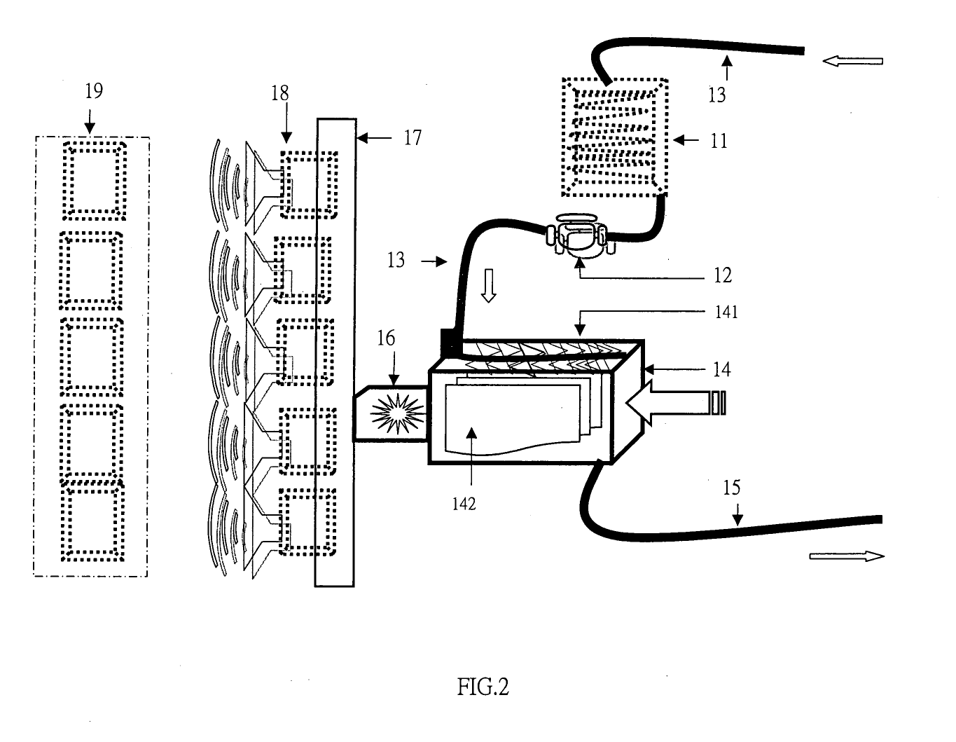

As seen in FIG. 2, the heat exchange system (1) provides filtered clean air into the cultivating area (2). In the summer day, when the temperature is above the predefined level, it uses endothermic capability of water and heat exchange mechanism to lower the air temperature of the greenhouse to between 22° C. to 30° C. (when the temperature is higher than 35° C., it is not suitable for vegetable growth). In the daytime of winter, it uses direct solar radiation to increase the air temperature of the greenhouse to between 12° C. to 30° C. When the temperature is lower than 5° C. and water temperature is higher than cold air, it uses the exothermic capability of water and heat exchange mechanism to increase the air temperature of the greenhouse to over 5° C. However, if water temperature is lower than cold air, it is to use other heat energy to increase the air temperature of the greenhouse to over 5° C. in order to prevent vegetable from frostbite. The system is to provide a suitable temperature and a clean non-polluted environment for vegetable growth. The heat exchange system (1) includes incoming water filtering pool (11), incoming water pump (12), incoming water hose (13), air washing machine (14), drain (15), blower (16), high-pressure blowing hose (17), incoming air filtration device (18), and outgoing air filtration device (19). The air washing machine (14) its comprising nozzles (141) and plate type heat exchange device (142). As the outside air goes through the air washing machine (14), it is also cleaning and washed freeing it of the dust, pest, spore and other particles suspending in the air from outside. The temperature of the exhausted water is raised a little bit after heat exchange with hot air. In addition, the temperature and the water quality of the exhausted water conform to the regulation of environmental protection bureau. The dust removal capability of the incoming air filtration device (18) is precisely 0.3 μm i.e. the efficiency of filtration is 99.97%. The dust removal capability of the exhausting air filtration device (19) is the same as the device (18) so as to avoid the polluting air to flow back into the greenhouse and also make sure the highest safety and sanitary environment for vegetable growth in the present invention.

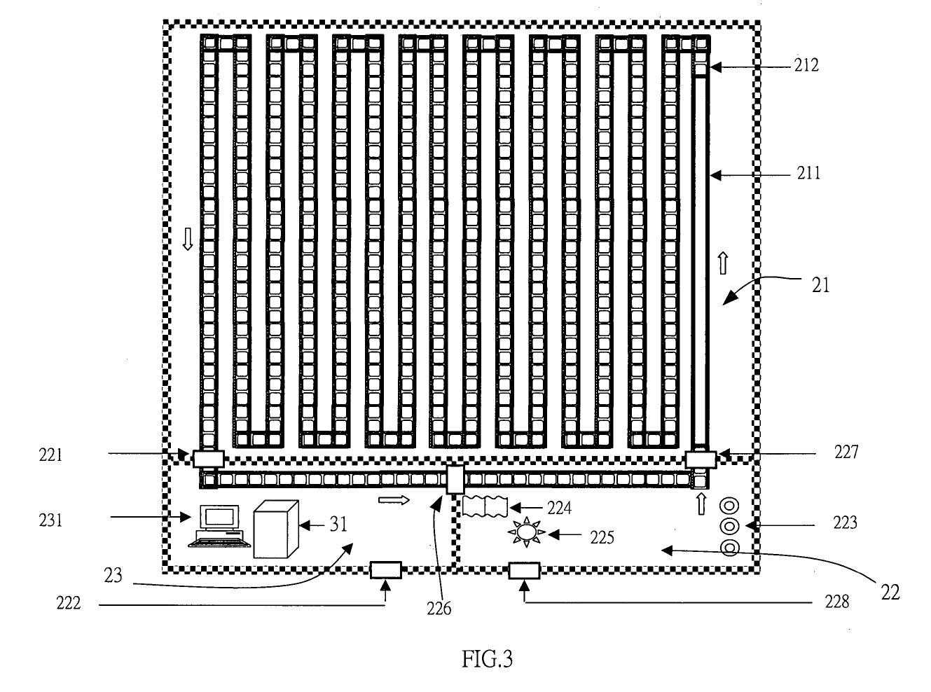

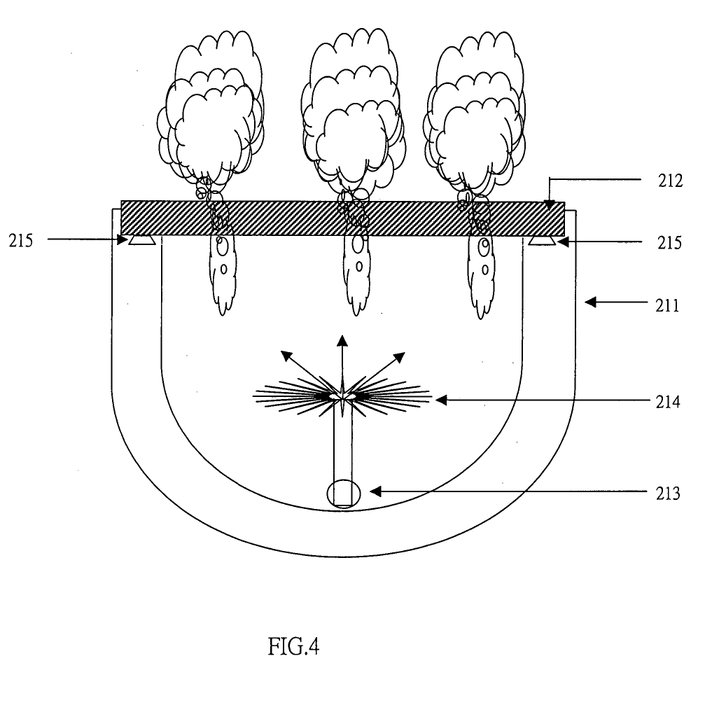

As seen in FIG. 3 and FIG. 4, the cultivating area (2) of the clean and airtight greenhouse is a closed tent structure made of transparent tempered glass and inside there is a cultivating area (21), a seedling nursery area (22) and a harvest area (23). Walls divide those three areas. The channel between the seedling nursery area (22) and the harvesting area (23) has the function of transporting the empty cultivating trays (212) and is divided by a door (226) to maintain the airtight area. Moreover, a door (227) and an airtight entrance gate (228) between the cultivating area (21) and the seedling nursery area (22) are divided by a double-door with only one to be opened at a time to prevent contamination between the areas.

In the present production example there are continually winding cultivating ditches (211) paralleled mutually in the cultivating area (21). Some of the cultivating ditches (211) are connected to the seedling nursery area (22) to be the initial point to move cultivating trays (212) into the cultivating area (21). Meanwhile, some of the cultivating ditches (211) are connected to the harvest area (23) to be the terminal point of cultivating trays (212) and then harvest the mature vegetable. From the sectional view of a cultivating ditch (211) is a U-shaped groove and at the bottom of the groove is a pipe (213) for nutrient solution delivery and several spray nozzles (214) can provide the nutrient solution or water to the roots of vegetable when vegetable has photosynthesis during the daytime. On the both sides of edges of the cultivating ditch (211) set slippery rails (215) to be the support of the cultivating trays (212) and making the cultivating trays (212) movable. The forward moving distance is according to the amount of vegetable cultivation everyday. Everyday it is to put in a fixed amount of cultivating trays (212) in the seedling nursery area (22) and make the previous cultivating trays move forward to the harvest area (23) in turn then again adds a fixed amount of cultivating trays (212) on the cultivating ditches (211) each day until all the seedling nursery area (22) is filled with cultivating trays (212) and the fixed amount of cultivating trays (212) are also the amount of harvest in the harvest area (23). It means it is to seed and harvest everyday and it debunks the traditional harvesting and seeding schedule of agriculture completely. In the cultivating ditches (211) there are pipes (213) and several spray nozzles (214) for delivering the nutrient solution. The pipes (213) for the nutrient solution delivery are connected with the outlet of the nutrient solution pump (315) of the nutrient solution preparation system (31) in the harvest area (23). In the seedling nursery area (22) there are several seedling nursery trays (223) especially for seed germination. The seeds of vegetable germinate and have their initial growth in the seedling nursery trays (223) and then it is transplanted to cultivating trays (212) and moved to the cultivating area (2) of the clean and airtight greenhouse for the next growth step. The vibrating and line-arranging machine (224) vibrates the seeds causing them to turn and roll and then separate individually. At the same time, all the seeds are passed through the ultraviolet exposure to be sterilized thoroughly then put in the seedling nursery trays (223) in order to prevent the clean greenhouse from being polluted by the bacteria. When the seedlings grow to a specified condition or size, the seedlings are transplanted to the cultivating trays (212) then through the cultivating ditches (211) to the cultivating area (21) for the cultivation and growth process. The harvest area (23) provides a place for vegetable harvest, package, quality control, and so on. The devices in the harvest area (23) are a gas chromatography device (GC) (231) and a nutrient solution preparation system (31). The gas chromatography device (231) is the application of quality control inspection that tests the nitrate contents of harvested vegetable everyday. If the value of nitrate contents of the harvested vegetable is higher than the definitions of standard operation process (S.O.P.), the vegetable will be destroyed. The nutrient solution preparation system (31) comprising a filter (311), a heater (312), a cooler (313), nutrient solution preparation tank (314) and a nutrient solution pump (315), which is the apparatus for preparing the needed nutrient solution and has the functions of filtration, sterilization, mixture and storage. The nutrient solution pump (315) is connected to the pipes (213) at the bottom of the cultivating ditches (211) and provides nutrient solution to all the spray nozzles (214) that spray the nutrient solution to the roots of vegetable at a optimal schedule. The water used for nutrient solution preparation passes through the apparatus (31) and is filtered by the filter (311) first then passes through the heater (312) to be heated to over 85° C. for more than 5 minutes to sterilize it. It is then passed through the cooler (313) to cool down, finally reaching the nutrient solution preparation tank (314) mixing and diluting with all the fertilizers. The pump (315) then transports the prepared nutrient solution to the pipes (213) and the spray nozzles (214) to offer the nutrient solution to the roots of vegetable at predetermined schedule. At the nighttime it is to stop spraying the nutrient solution for not only saving the nutrient solution but also avoiding the insufficient metabolism and the accumulation of nitrate. Generally the sunlight will ignite the chain reaction inside the leaves of the vegetable and making it undergo photosynthesis to transfer nitrate to protein, whereas after sunset the vegetable will close the chain reaction and stop photosynthesis. The present invention is to customize to the need of a particular vegetable and set up the nutrient solution content, spray schedule and length of spray base on its needs. This allows the vegetable to grow efficiently without wasting nutrients and prevents build up of nitrates in the vegetable. When the vegetable is near harvest time, only water is spray to the vegetable, thus allowing the vegetable to convert nitrate to protein completely. This is assuring that the harvested vegetable conforms to the stringent health standards.

The present inventive functions are based on the application of first and second laws of thermodynamics. According to the first law, total energy of the system plus the surroundings is constant. The airtight greenhouse is a system that, when properly isolated, requires little energy to maintain a desired temperature. As for the second law, energy spontaneously tends to flow only from being concentrated in one place to becoming or dispensed and spread out, and also heat propagates by means of radiation it is used to design an innovative agricultural system needed to control the temperature in the present airtight contaminant-free greenhouse cultivation system.

The above description of the present production example is only an application by using basic heat exchange method to control a desired temperature range suitable for vegetation growth in the present airtight cultivation system. There is on limitation of using once, twice, even multiple heat exchange function regarding the analogical application in a greenhouse cultivation system.

I claim:

1. An environmental protection greenhouse with clean and airtight cultivation system comprising at least one air control equipment by using the energy of natural water to facilitate the heat exchange mechanism and one airtight greenhouse. The air control equipment is composed of an incoming water filtering pool (11), an incoming water pump (12), incoming water hose (13), air washing machine (14), drain (15), blower (16), high-pressure blowing hose (17), incoming air filtration device (18), and exhausting air filtration device (19). The airtight greenhouse is divided into a cultivating area (21), a seedling nursery area (22) and a harvest and quality control area (23).

2. An environmental protection greenhouse with clean and airtight cultivation system according to claim 1, wherein the air washing machine (14) comprising nozzles (141) and plate type heat exchange device (142). An environmental protection greenhouse with clean and airtight cultivation system according to claim 1, which has doors separating the different sections. In particular, there are two entrances to the airtight green house. Both of these entrances are guarded by double doors to prevent air flowing from one area to another directly.

3. An environmental protection greenhouse with clean and airtight cultivation system according to claim 1, which has continually winding cultivating ditches (211) that are parallel maximizing the number of trays in the cultivating area (21) and these are movable cultivating trays (212) on top of the cultivating ditches (211).

4. An environmental protection greenhouse with clean and airtight cultivation system according to claim 1, wherein the seedling nursery area (22) comprising the seedling nursery trays (223), a vibrating and line-arranging machine (224) and an ultraviolet lamp (225).

5. An environmental protection greenhouse with clean and airtight cultivation system according to claim 1, wherein the harvest and quality control area (23) comprising a gas chromatography device (GC) (231) and a nutrient solution preparation system (31).

6. The apparatus according to claim 4, wherein the cultivating ditch (211) is a U-shaped groove and on the both sides of the cultivating ditch (211) edges contain slippery rails (215) to support the cultivating trays (212) and allowing the cultivating trays (212) to move. At the bottom of the groove there are a pipe (213) and several spray nozzles (214) for the nutrient solution delivery.

7. The apparatus according to claim 6, wherein the nutrient solution preparation system (31) comprising a filter (311), a heater (312), a cooler (313), a nutrient solution preparation tank (314) and a pump (315) for nutrient solution transportation.
